(19) United States
(12) Patent Application Publication
(10) Pub. No.: US 2012/0246557 A1
(43) Pub. Date: Sep. 27, 2012

(54) SYSTEM AND METHOD FOR TRANSCODING WEB CONTENT ADAPTABLE TO MULTIPLE CLIENT DEVICES

(75) Inventors: Ramprasath Venugopal, Chennai (IN); Amarendranath Turga, Chennai (IN); Bala Aravind Ganesan, Chennai (IN)

(73) Assignee: HCL TECHNOLOGIES LIMITED, Tamil Nadu (IN)

(21) Appl. No.: 13/501,378

(22) PCT Filed: Oct. 4, 2010
(86) PCT No.: PCT/IN2010/000655

§ 371 Date: Jun. 8, 2012

(30) Foreign Application Priority Data
Oct. 12, 2009 (IN) 2482/CHE/2009

(51) Int. Cl. G06F 17/00

(52) U.S. Cl. 715/234

(57) ABSTRACT

System and Method for processing and transmitting web site content to a class of client devices are described. The web page content is configured to make it compatible or adaptable to a class of client devices and is stored. As per the type of the client device issuing a request for the web page, the web page is transcoded and modified at runtime according to a stored configuration and finally transmitted to the client device for displaying.

### TECHNICAL FIELD

The present invention relates to a system and method for processing and transmitting web site content to a class of client devices and more particularly for transcoding the web site content and enabling the display of the formatted and modified content on the variety of client devices.

### BACKGROUND

There is a rapidly increasing use of the internet for commercial and non commercial transactions. These transactions allow a user to use and access the products or services offered by a web site. These interactions take place by the use of graphical forms that allow a user to receive and submit information. The use of these interactive graphical forms for transactions has generally required the use of conventional display screens for viewing the graphical content.

Increasingly, pervasive devices such as personal digital assistants, handheld computers, smart phones, TV browsers and mobile devices are becoming popular for business and personal use due to the relatively increase in number of services and features that the devices and mobile infrastructures support. One of the services provided by the mobile devices is access to IP networks, and to act as HTTP web client to retrieve and display web pages that have been composed using a markup language such as HTML. However, web pages composed of HTML are generally designed for large viewing screens having at least 640×480 pixels such as those incorporated in desktop computers and laptops. In addition, the capacity of these devices to receive, store and display internet content varies widely. Mobile viewing and desktop viewing differ from the perspectives of mobile screen size, screen layout, number of colors, screen resolution, limitations like no horizontal scrolling, limited bandwidth, limited Internet protocol and language support. Further, the way of using internet by mobile viewers and desktop viewers is entirely different. A mobile viewer doesn't want unwanted information like advertisements to flow into his/her device and he/she even doesn't want to scroll through it. There are provisions available for programs embedded in HTML to detect client screen size and adjust the display of data accordingly. However, it is often extremely difficult for a mobile device to process and render received HTML data effectively on a small screen, because the mobile device has to choose which aspects of the HTML data are to be rendered using the limited choice of pixels and which are to be excluded.

Various systems and methods have been devised that provide mobile devices having small screens with formatted content, without requiring the devices to choose which elements of the data should be rendered. The alternative protocols and display standards such as Handheld Device markup Language (HDML) or Wireless Markup Language (WML) are available to provide content to devices having reduced screen size, processing and bandwidth capacity. Content providers maintain their content in two different formats, and serve one or the other of the formats depending on the type of client requesting. This dual format approach requires significantly greater effort on the part of the content provider and additional storage space.

To enable the universal access, systems are being developed that tailor the content of the web pages for pervasive computing devices. This tailoring process is called transcoding. The transcoding system adapts video, image, audio and text to the individual devices using a method that allows the content to be summarized, translated and converted on the fly. This is done by transcoding the web site content into any Markup language that the device supports. However, perfect transcoding of the rather loose and flexible HTML standard is very difficult to achieve. Another, problem is that HTML pages often include embedded programs designed to be interpreted by the client for display purposes that are often lost during transcoding because they cannot be executed by a WML browser. Since, HTML pages do not separate content from representation, many transcoding systems result in a translation that results in a loss of meaning and functionality.

To overcome the above stated limitations and disadvantages, different system and methods have been devised that provide an improved technique of transcoding web content.

US 2006/0048051 provides a method for transmitting formatted content to a mobile device having a small display screen comprises retrieving a page of formatted content, rendering the page as a graphic such as a JPEG that is sized for display on the small display screen, and transmitting the graphic to the requesting device for display. Hyperlinks are collected and sent with the graphic and are presented as menu options on the device for selection by a user. The user may then request a zoom-in to a portion of the graphic and have a corresponding portion of the page transmitted to the device. The returned web page portion operates as a typical formatted content page, permitting the user to read the contents, select a hyperlink or enter data into a form. A method for displaying a large graphic files on a mobile device having a small display screen comprises requesting the graphic file from a server, in response to the request, receiving the graphic file scaled for display and an identification of portions of the graphic file; displaying said graphic file and an overlaid grid corresponding to said identification of portions of said graphic file. Using the grid, a portion of the graphic file is selected and requested from the server, received and displayed.

U.S. Pat. No. 7,120,702 provides a computer-implemented method and system for processing transactions between a client device and a web page. The system includes an adapter for receiving and interpreting a request from the client device, wherein the adapter is configured to interface with the client device. A generator retrieves a web page specified by the request. A transcoder receives the retrieved web page and applies a transcoding rule to extract data from the web page. The transcoding rule used is one of a set of predefined rules relating to the web page. The transcoder also transforms the data into a standardized form so that the adapter can then modifying the standardized data into a compatible form for display by the client device. Therefore, web based transactions can be performed by a variety of client devices, including portable, wireless and voice-based devices.

U.S. Pat. No. 6,715,129 provides a method, system, and computer program product for using Java Server Pages to enable transcoding the content of a document requested by a client, in order to tailor the output document according to application-specific characteristics. In particular, the present invention enables the JSP author to override input source request characteristics and to specify transcoding hints to be used by a transcoding filter for selecting an appropriate style sheet.

The above methods are laborious process and prone to errors. The web content is delivered in image formats, as a result it requires larger bandwidth. Since the formatting is pre-defined, page dependant alterations are not possible. The implementation based on style sheets is suitable for very basic sites where the layout is not so complicated and where not much transcoding is needed. Web pages or sites with more intricate layouts or with advanced controls or with multimedia cannot be transcoded with this implementation. The method of transcoding the web content has a one time definition of transcoding rules. There are no page dependant customizations possible in the above mentioned systems and methods. These systems and methods do not provide the level of flexibility and accuracy in transcoding the web content. Hence, they are narrowed and do not serve the specific requirements of the final user.

Hence, there is a need of a system and method which overcomes the above-mentioned limitations. There should be a system and method that allows page dependant alterations at runtime using wide variety of configurations for different categories of mobile devices and should be feasible for transcoding complex web sites. Additionally it should not consume much bandwidth so as to make the retrieval and display of the transcoded web site content slow on the client device or the mobile device.

### OBJECTS AND SUMMARY

The object of the present invention is to provide a system and method for processing and transmitting web site content to a class of client devices.

It is an object of the present invention to provide a designer tool that allows the client device administrator to modify and manipulate the web site content at design time to make it compatible with the client device.

It is another object of the present invention to transcode the web site content at runtime as per stored design time configurations and enables the display of the formatted and modified content on the variety of client devices.

It is yet another object of the present invention to implement cache based transcoding for faster retrieval of web page by the client device.

It is still another object of the instant invention to provide the transcoding of the internet, intranet and extranet based web site content.

To achieve the aforementioned objects, the present invention provides a method for processing and transmitting web site content to a client device, said method comprising the steps of:
a. configuring and storing a web page content to be adaptable for a client device or a class of client devices;
b. identifying the client device issuing a web page request;
c. transcoding and modifying the web page at runtime according to stored configuration to make it compatible with the client device; and
d. transmitting the transcoded and modified web page to the client device.

The present invention further provides a system for processing and transmitting web site content to a client device, said system comprising of:
a. means for configuring and storing a web page content to be adaptable for a client device or a class of client devices;
b. means for identifying the client device issuing a web page request;
c. means for transcoding and modifying the web page at runtime according to stored configuration to make it compatible with the client device; and
d. means for transmitting the transcoded and modified web page to the client device.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates the exemplary network architecture for processing and transmitting the web site content to the mobile devices according to the present invention.

FIG. 2 illustrates the different exemplary components for transcoding the web site content to make it compatible with the client device according to the present invention.

FIG. 3 illustrates the exemplary method for processing and transmitting the web site content to the mobile devices according to the present invention.

FIG. 4 illustrates the exemplary designer tool for modifying and manipulating the web site content according to the present invention.

### DETAILED DESCRIPTION OF THE DRAWINGS

System and method for processing and transmitting web site content to a class of client devices is described. The system and method is not intended to be restricted to any particular form or arrangement, or any specific embodiment, or any specific use, disclosed herein, since the same may be modified in various particulars or relations without departing from the spirit or scope of the claimed invention herein shown and described of which the system and/or method shown is intended only for illustration and disclosure of an operative embodiment and not to show all of the various forms or modifications in which this invention might be embodied or operated.

The instant invention describes a system and method for processing and transmitting web site content to a class of client devices. The words “client device” and “mobile device” are used interchangeably. In a preferred embodiment of the instant invention, the said system and method provides a mobile web wrapper designer (MWW designer) tool that assists the web site administrator to view and configure the web page using WYSIWYG editor. The administrator can also modify the look and feel of the web page by using various wizards provided by the designer which is a one-time activity. The administrator can see a preview of the site before deployment so that he/she can manipulate the site as per his/her requirements. Once the administrator finalizes the changes, the configurations are stored in an XML file known as Mobile Server Pages (MSP). The other component is mobile web wrapper proxy (MWW proxy) consisting of various components that identifies the source of web page request which can be either from a desktop user or from a mobile user. MWW proxy loads an appropriate MSP file created by the MWW designer, modifies the web page content as per the MSP file and administrator configuration and then routes the content to the appropriate user for viewing on the client device.

The techniques described herein may be used in many different operating environments and systems. An exemplary environment that is suitable for practicing various implementations is discussed in the following section with respect to the accompanying figures.

### Exemplary System

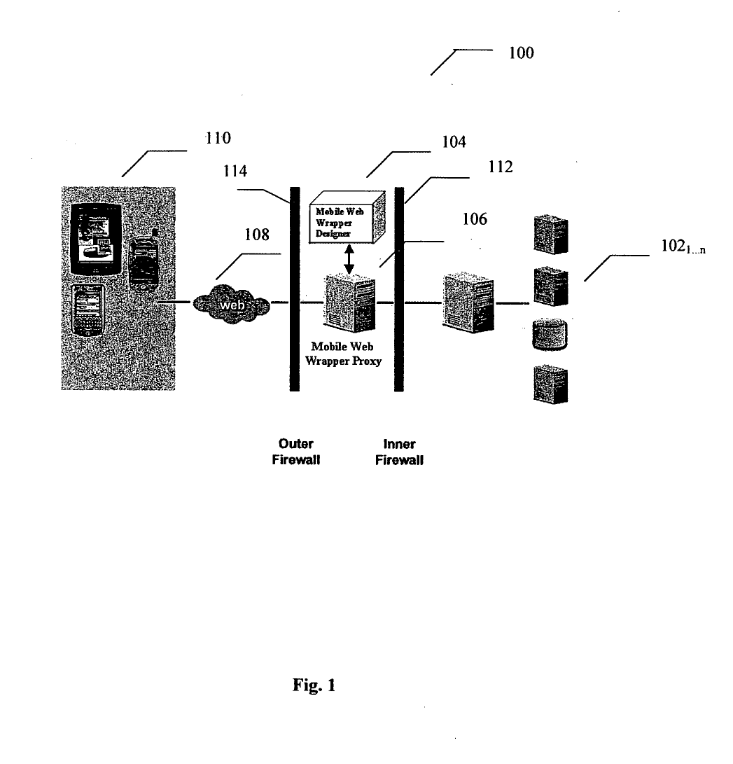

FIG. 1 illustrates the exemplary network architecture 100 for processing and transmitting the web site content to the mobile devices according to the present invention.

The network 100 incorporates plurality of web servers 102_{1 . . . n}, MWW proxy 106 with MWW designer 104 and one or more mobile devices 110. All the components of the network communicate via a wireless network 108. MWW proxy 106 communicates with the web servers 102_{1 . . . n} through an inner firewall 112. The inner firewall 112 resides between the DMZ (demilitarized zone) and the subnets that are not accessible to the public. The DMZ is a portion of the network that separates a purely internal network from an external network. The mobile devices 110 communicate with the MWW proxy through an outer firewall 114. This outer firewall 114 resides between internet and the organization network which can be intranet. The servers 102_{1 . . . n} can host web sites or graphic download sites, providing access to picture files such as JPEG, TIFF, BMP, GIF etc. The wireless network 108 can include GSM/GPRS, CDMA, TDMA, iDEN, Mobitex or any other wireless network already available or known in the prior art. The mobile devices can include cellular phones, smart phones, PDAs, laptops, notebook computers or tablet PC. These mobile devices have the configuration and the features presently available in the market.

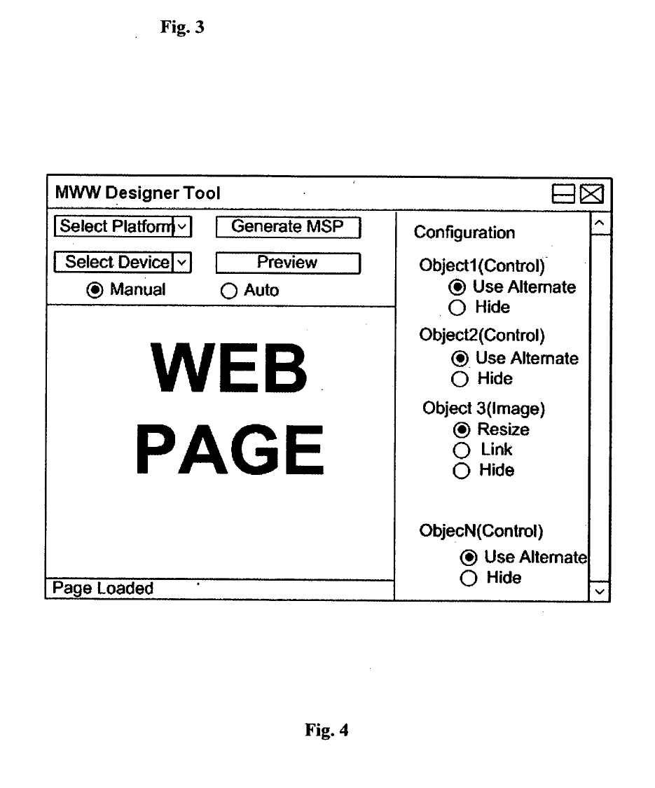

The MWW designer 104 as illustrated in FIG. 4 can assist the web site administrator to configure the web page downloaded from the web servers 102_{1 . . . n}. It has various controls as shown on the right side of FIG. 4 and the options for manually or automatically modifying the web page. It also includes options for selecting the platform of the client device, generating mobile server pages, type of the client device and previewing the web page once it is configured by the administrator of the web site. The web page is configured so as to make it compatible or adaptable with the client device. This is a one-time activity performed by the administrator with the help of WYSIWYG editor provided by the MWW designer. The administrator can see a preview of the web page before deployment so that it can be manipulated as per the administrator's requirements. The WYSIWYG editor provides three views that are normal view, source code view and preview in the mobile emulator. The web page can be further altered by adding code snippets through source code view. MWW designer also provides a variety customized templates and in-built wizards available in the normal view to alter the look and feel of the web page and can manipulate it according to the device limitations. These wizards can also provide pagination of the web pages that are configured and modified. After the changes are finalized, the resulting configurations and modifications are stored in an XML file which is a Mobile Server Pages (MSP) file.

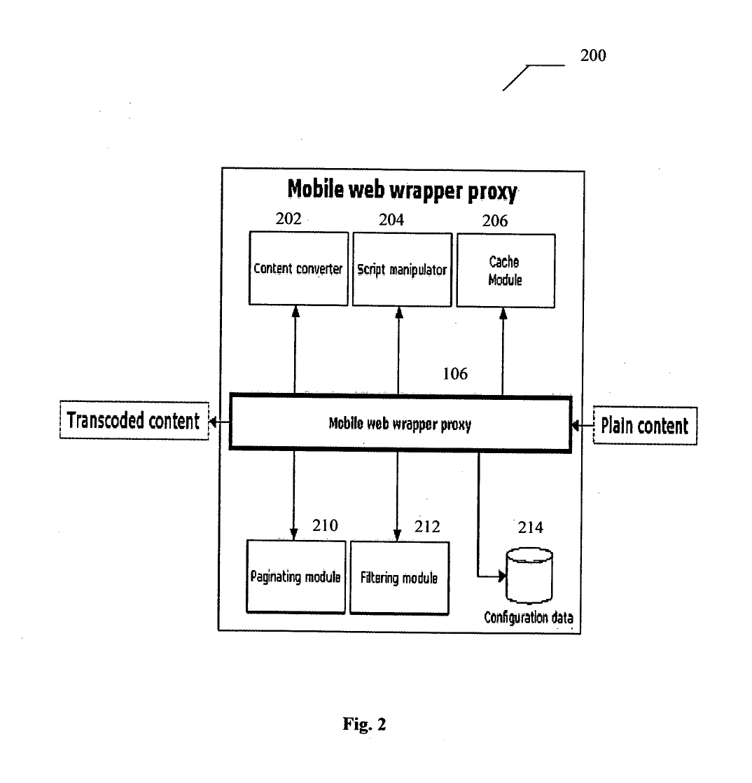

Another component in the network architecture 100 is MWW proxy 106 as illustrated in FIG. 2 which can identify the source of web page request i.e. whether the request is sent by a desktop user or by a mobile device. It identifies the class of mobile devices and loads an appropriate MSP file created by the MWW designer and transcodes and modify the content at runtime as per the administrator configuration and thereafter transmits the content to the mobile device 110 through the outer firewall 114. The MWW designer and MWW proxy is mostly deployed for mobile enabling intranet portals but can be extended to internet and extranet based web sites where the changes in the layout of the sites is not so frequent thereby making, mobile enabling quick and accurate.

FIG. 2 illustrates the different exemplary components of MWW proxy 106 for transcoding the web site content or plain content to make it compatible with the client device according to the present invention.

The first component is Configuration database 214 where the MWW Designer 104 stores the configuration of each page for each device or for a set of devices. MWW Proxy 106 uses this component for transcoding the content.

The second component is Content converter 202 which uses the configuration data to convert the content as per the requirements. Transcoding tabular content, manipulating controls, changing the layout of the page, manipulation of binary content like images, flash files, etc. are some of the functionalities of this component.

The third component is Script manipulator 204 which manipulates the script content of the web page. This can further be componentized depending on the script manipulating abilities of the application.

The fourth component is Cache module to which the content to be transcoded is first routed so as to utilize the caching functionality, if any. The use of this component can make the process of transcoding and the retrieval of web page faster by the client device.

The fifth component is Filtering module which is used to add or delete the content of the page depending on the configuration data for example the content located in headers, footers and in advertisements generally proves to be not so useful. This module deletes the content as per the requirements. Also, this component can add some mobile device specific code.

The sixth component is Pagination module which provides the pagination for the web page content to make it suitable for mobile devices.

### Exemplary Method

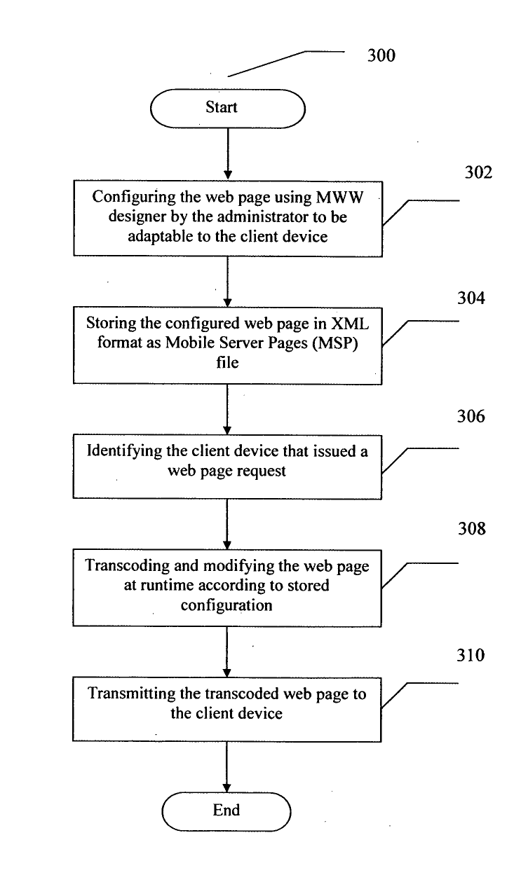

FIG. 3 illustrates the exemplary method 300 for processing and transmitting the web site content to the mobile devices according to the present invention. The method is illustrated as a collection of steps in a logical flow graph, which represents a sequence of operations that can be implemented in hardware, software, or a combination thereof. The order in which the process is described is not intended to be construed as a limitation, and any number of the described steps can be combined in any order to implement the process, or an alternate process. Additionally, individual steps may be deleted from the process without departing from the spirit and scope of the subject matter described herein.

The web page is configured by the administrator of the web site using MWW designer to make it compatible with the client device (step 302) as described in FIG. 1. The configured web page is then stored in XML format as MSP file using which the requested web page is transcoded and modified (step 304). The MWW proxy identifies the type of the client device that issued a web page request (step 306). The requested web page is then transcoded and modified as per the stored configuration (step 308). The final transcoded web page is transmitted to the client device through the wireless network for mobile enabling (step 310).

The embodiments described above and illustrated in the figures are presented by way of example only and are not intended as a limitation upon the concepts and principles of the present invention. Elements and components described herein may be further divided into additional components or joined together to form fewer components for performing the same functions. As such, it will be appreciated by one having ordinary skill in the art that various changes in the elements and their configuration and arrangement are possible without departing from the spirit and scope of the present invention as set forth in the appended claims.

1. A method for processing and transmitting web site content to a client device, said method comprising the steps of:
a. configuring and storing a web page content to be adaptable for a client device or a class of client devices;
b. identifying the client device issuing a web page request;
c. transcoding and modifying the web page at runtime according to stored configuration to make it compatible with the client device; and
d. transmitting the transcoded and modified web page to the client device.

2. The method as claimed in claim 1, wherein the client device includes a cellular phones, smart phones, PDAs, laptops, notebook computers or tablet PC.

3. The method as claimed in claim 1, wherein the web page is configured by an administrator of the web site using a user interface designer tool.

4. The method as claimed in claim 3, wherein the user interface designer tool consists of a WYSIWYG editor for configuring and manipulating the web page.

5. The method as claimed in claim 1, further comprising the step of previewing the web page by the administrator of the web site.

6. The method as claimed in claim 1, further comprising the step of implementing cache based transcoding for faster retrieval of web pages by the client device.

7. The method as claimed in claim 1, wherein the web page is transcoded based on the stored configuration in a structured data format for rendering the content on the client device.

8. The method as claimed in claim 1, wherein the web site content is internet based, intranet based or extranet based.

9. A system for processing and transmitting web site content to a client device, said system comprising of:
a. means for configuring and storing a web page content to be adaptable for a client device or a class of client devices;
b. means for identifying the client device issuing a web page request;
c. means for transcoding and modifying the web page at runtime according to stored configuration to make it compatible with the client device; and
d. means for transmitting the transcoded and modified web page to the client device.

10. The system as claimed in claim 9, wherein the client device includes a cellular phones, smart phones, PDAs, laptops, notebook computers or tablet PC.

11. The system as claimed in claim 9, wherein the web page is configured by an administrator of the web site using a user interface designer tool.

12. The system as claimed in claim 11, wherein the user the user interface designer tool consists of a WYSIWYG editor for configuring and manipulating the web page.

13. The system as claimed in claim 9, further comprising the means for previewing the web page by the administrator of the web site.

14. The system as claimed in claim 9, further comprising means of implementing cache based transcoding for faster retrieval of web page by the client device.

15. The system as claimed in claim 9, wherein the web page is transcoded based on the stored configuration in a structured data format for rendering the content on the client device.

16. The system as claimed in claim 9, wherein the web site content is internet based, intranet based or extranet based.

17. A computer program product comprising means for configuring the web page to be adaptable for rendering on a client device as claimed in step a of claim 1.

18. A computer program product comprising means configured for processing and transmitting web site content to a client device as claimed in claim 1.

19. A computer program product comprising means configured for processing and transmitting web site content to a client device as claimed in claim 2.

20. A computer program product comprising means configured for processing and transmitting web site content to a client device as claimed in claim 3.
